(19) United States
(12) Patent Application Publication
(10) Pub. No.: US 2007/0144661 A1
(43) Pub. Date: Jun. 28, 2007

(54) Method for cold film embossing

(75) Inventors: Uwe Puschel, Heidesheim (DE); Jurgen Scholzig, Mainz (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: MAN Roland Druckmaschinen AG, Offenbach (DE)

(21) Appl. No.: 11/643,547

(22) Filed: Dec. 21, 2006

(30) Foreign Application Priority Data
Dec. 27, 2005 (DE) 102005062498.7

(51) Int. Cl. B44C 1/17; B32B 37/12; B32B 37/00

(52) U.S. Cl. 156/234; 156/233; 156/241; 156/578; 156/540; 156/582

(57) ABSTRACT

The present invention improves the guiding of the transfer film in a coating module for transferring image-forming layers from the transfer film onto a printing sheet. For this purpose, a limited pressing face is arranged in the coating module that allows the film advance to be controlled in a targeted manner. In the coating module, the transfer film can be guided past a portion of the width of a press roll in an approximately tangential manner.

### FIELD OF THE INVENTION

The present invention relates to an apparatus and a method for transferring image-forming layers from a support film onto printing sheets.

### BACKGROUND OF THE INVENTION

Producing metallic layers on printing sheets using a foil or film transfer process is known. For example, a printing material and a printing apparatus which uses the printing material are described in EP 0 569 520 B1. In that reference, a sheet-processing machine is disclosed that includes a feeder and a deliverer. Printing units and a coating module being arranged between the feeder and the deliverer. An adhesive pattern is applied by a planographic printing process in at least one of the printing units. The adhesive pattern is applied using a cold printing process and has a defined image-forming design. A film guide is provided in the coating module which follows the printing unit. The film guide has an impression or backing cylinder and a press roll. The film guide is designed in such a way that a film strip or a transfer film is guided from a film supply roll through the transfer nip of the coating module between the impression or backing cylinder and the press roll. The film strip is rewound on the exit side after leaving the coating module. The transfer film has a carrier layer on which image-forming layers can be applied such as metallic layers (e.g., made of aluminum). A separating layer is provided between the metallic layer and the support film. The separating layer ensures that the metallic layer can be pulled off from the carrier layer.

During the transport of printing sheets through the printing unit, each printing sheet is provided with an adhesive pattern. The printing sheet is then guided through the coating module. In the coating module, the printing sheet which lies on the impression cylinder is brought into contact with the film material by the press roll. Here, the metallic layer on the bottom becomes tightly bonded to those regions on the printing sheets provided with adhesive. After further transport of the printing sheet, the metallic layer adheres only in the region of the adhesive pattern. As a result, the metallic layer is removed from the support film in the region of the adhesive pattern. The used transfer film is then rewound. The printing sheet is delivered in the coated state.

It is known to use coating modules of this type in printing units of printing presses. However, a disadvantage of these modules is that they cannot be employed in a flexible manner.

### BRIEF SUMMARY OF THE INVENTION

In view of the foregoing, an object of the invention is to provide an apparatus that can transfer an image-forming layer onto a printing sheet in a reliable, economical and precise manner. Such apparatus can be used in a wider variety of applications. In particular, partial film application is possible.

Advantageously, the apparatus of the present invention includes a press roll having a pressing face or cover which assumes a partial surface of the overall surface of a printing sheet. Such pressing covers can be configured as clampable segments or as partial rubber blankets. Alternatively, the pressing faces can be configured as preferably photopolymeric relief printing plates that are manufactured with an accurate fit or as releasably attachable (e.g., via magnets) pressure segments.

A variety of different working materials can be used for the pressing cover. For example, a so-called stripped rubber blanket in which the pressing surface has been removed as far as the active surface can be used. A polymeric cutting plate (e.g., from manufacturing printing plates via a flatbed plotter) that optionally has a support material made of aluminum or polyester can be used. Additionally, a photopolymeric plate (e.g., from an exposure operation) that optionally has an aluminum plate/film as a support material could be used. A rubber blanket that is applied to a metal support also can be used. Such a rubber blanket can optionally have a damping intermediate layer and be provided with a thin, hard and smooth covering layer. A support (e.g., a printing underblanket) with or without a damping action can be provided as a base for the corresponding partial press cover material.

Clamping systems that can be used include clamping spindles such as are known in a rubber-covered cylinder. Alternatively, so-called combination clamping rails for printing blankets or printing plates, such as are known from rubber-covered or form cylinders, can be used. Depending on the construction, the surface of the press roll cover also can be used for profiled embossing.

This configuration results in cold film embossing being usable across a broader spectrum of applications. The changeover time can be shortened by using pre-prepared press roll covers. Moreover, register automation can be introduced. The press roll also can be configured with a register system, for example via register pins. The press roll can be adjustable, for example in the manner of a register system for automatic printing-plate clamping. The lateral and circumferential register can be set in the same way as in a form cylinder. Moreover, the press roll cover can be provided with register punched portions.

The apparatus of the present invention can also advantageously be used to improve utilization of the transfer film by dividing the transfer film into one or more partial film webs of smaller width. With such an arrangement, different film types can be used next to one another.

To enhance the efficiency of the coating method of the present invention, the film advance can be controlled in such a way that the transfer film is stopped when the image-forming layer or metallic layer is not being transferred. For instance, the transfer film can be controlled in such a way that the film advance is stopped during passage of a cylinder channel which accommodates the grippers of the sheet-guiding impression cylinder. In such cases, the press roll then passes through in a sliding manner under the transfer film.

In order to enhance the glossiness, the image-forming layer can be applied using so-called UV underprinting ink. The UV underprinting ink can be applied by the printing unit used to apply the adhesive in a corresponding manner via an offset printing plate.

It is also possible to arrange a plurality of coating modules one after another within a sheet-processing machine. With such an arrangement, different image-forming coatings or metallic layers can be applied one after another within one design. The image-forming layers can be transferred next to one another via a single adhesive pattern having all the image-pattern elements. Alternatively, a first adhesive pattern can be provided in a first coating module with a first image-forming coating or metallic layer and a further adhesive pattern can then be superimposed on the first adhesive pattern which is then used to transfer another image-forming coating or metallic layer.

### BRIEF DESCRIPTION OF THE SEVERAL VIEWS OF THE DRAWING(S)

FIG. 1 is a schematic side view of an illustrative printing press having a film transfer device according to the invention.

FIG. 2 is a schematic side view of an illustrative coating module having a film transfer device according to the invention.

FIG. 3 is a schematic side view of the press roll of the coating module of FIG. 2.

FIG. 4 is an enlarged schematic side view showing a portion of the press roll of FIG. 3.

### DETAILED DESCRIPTION OF THE INVENTION

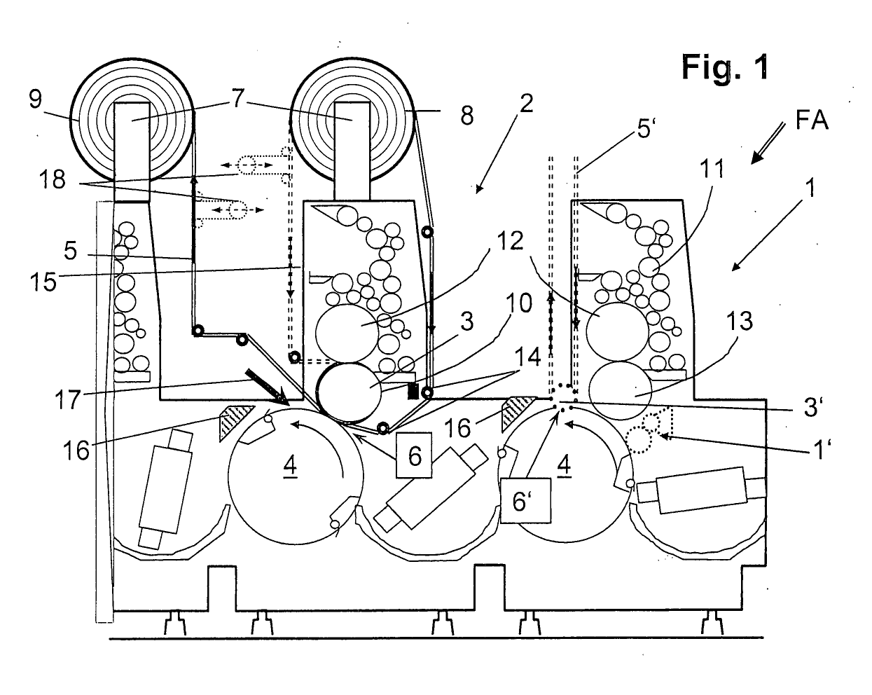

Referring to FIG. 1 of the drawings, a sheet-fed rotary printing press is shown which includes two printing units. The illustrated printing press can be used such that a printing sheet is first provided with a full-surface or image-forming adhesive pattern in the first printing unit, which in this case is functioning as applicator unit 1. In the following second printing unit, which in this case is functioning as a coating unit 2, the printing sheet is guided under pressure through a transfer gap or nip 6 together with a transfer film 5.

The applicator unit 1 can comprise a known offset printing unit that includes an inking unit 11, a plate cylinder 12 and a blanket cylinder 13. The blanket cylinder 13 interacts with a backing or impression cylinder 4. The coating unit 2 can likewise be formed by an offset printing unit. The transfer nip 6 in the coating unit 2 is formed by a press roll or cylinder 3 and a backing cylinder 4. The press roll 3 can correspond to the blanket cylinder or it can correspond to the form cylinder of a varnishing module. In the illustrated embodiment, a web-guide 14 for the transfer film is provided within the coating unit 2. In this case, the transfer film 5 is guided in and out again by protection elements 15 associated with the coating unit 2.

Alternatively, as is shown in FIG. 1 in conjunction with the applicator unit 1, a film transfer device which is integrated into the applicator unit 1 can be provided. As a result of such an arrangement, an integrated film application module is provided. In this case, a printing nip between a blanket or form cylinder 13 and the impression cylinder 4 is assigned to the impression cylinder 4 in a downstream manner to a press roll 3′. A film web 5′ of a transfer film can be fed to a transfer nip 6′ after coating of the printed material via the applicator unit 1. The film web 5′ can then be guided directly away. The cold film embossing therefore takes place in a single integrated film application module FA.

As is shown schematically in FIG. 1, an applicator unit of compact design can also be arranged within the coating module in the integrated film application module FA. To this end, an adhesive applicator device 1′ can be assigned to the backing cylinder 4. The adhesive applicator device is arranged in front of the transfer nip that is provided between the blanket cylinder 13 and the backing cylinder 3. In this case, the transfer film can be guided around the blanket cylinder 13 or approximately tangentially past it through the printing nip.

The adhesive applicator device 1′ can comprise a compact form cylinder for supporting a printing form for the adhesive and an applicator unit comprising a chamber-type doctor and an engraved roll. The application of the adhesive to the printing material is again first performed in an integrated manner on the same impression cylinder 4 and the film application is carried out directly following this.

A film supply roll 8 is assigned to the coating unit 2 on the side of the sheet feeder. The film supply roll 8 has a rotary drive 7 for the continuous controlled feeding of the transfer film to the coating unit 2. In the film feeder, deflecting or tensioning rolls can be provided for guiding the transfer film 5 with a substantially constant tension relative to the press roll 3. A film collecting roll 9 for the used film material is provided on the outlet side of the printing unit. Advantageously, the film collecting roll 9 can be provided with a rotary drive 7. The transfer film 5 can be conveyed on the outlet side by the rotary drive 7 and can be held taut on the feed side by a brake.

The press roll 3, which can comprise a blanket cylinder, form cylinder or separate press roll, carries a compressible or damping element on its surface that can have an associated compressible intermediate layer. To this end, the press roll 3 can be provided with a press cover 10 (e.g., a plastic cover comparable to a rubber blanket or printing blanket) that is held using clamping devices provided in a cylinder channel.

To enhance the efficiency of the coating method, the advance of the transfer film 5 from the film supply roll 8 to the transfer nip 6 and to the film collecting roll 9 can be controlled in a stepped manner. In particular, the transfer film 5 can be stopped when on image-forming or covering layers are to be transferred. The associated apparatus preferably comprises a corresponding advance controller for the transfer film 5. The advance controller ensures that at least the part of the film web which lies in the region of the press roll 3 and the impression cylinder 4 is at a standstill when passing through the cylinder channel.

A further improvement in the utilization of the transfer film results if the transfer film 5 is divided into one or more partial film webs of a smaller width. The utilization of the transfer film 5 can also be improved in situations where one sheet has coating regions of different zonal length by providing an appropriate control using the device or devices for synchronizing the advance of each of the partial film webs.

Dryers 16 also can be provided in the film application module (in this case, the applicator unit 1 and the coating unit 2). The adhesive application or the entire film coating can be dried via the dryers 16. In this instance, UV dryers are one preferred type of dryers.

The film application module can also include a monitoring device 17 for sensing the sheet surface. The monitoring device 17 can enable the image contents of the coating to be evaluated and enable faults in the film coating to be determined. Such a monitoring device can also be provided in conjunction with the printing press into which the film application module is integrated. The monitoring can then be arranged, for example, in the sheet deliverer or a last printing unit of the printing press.

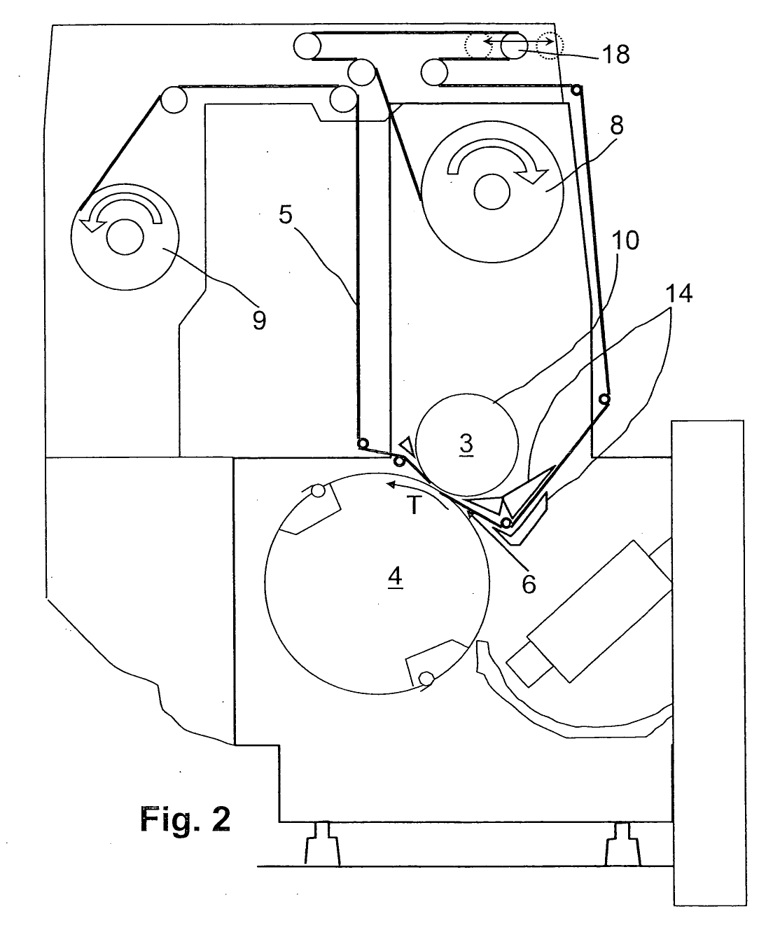

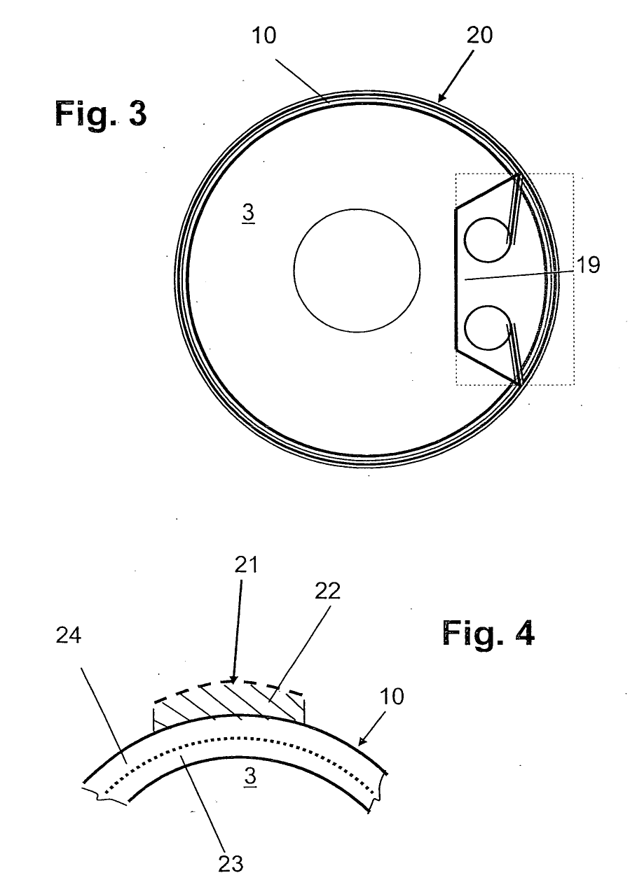

In order to improve the layer transfer and the coating result, the coating module can be provided with devices for conditioning the transfer film as shown in FIG. 2. In the illustrated embodiment, the film web 5 can be influenced by the film guiding device 14.

According to one particular aspect of the invention, a contoured or segmented pressing face 21 is provided as the surface of the press roll 3. In particular, a segmented pressing face 21 that is limited in size to one or more regions that are to be coated is used on the press roll 3 instead of a pressing face 20 the extends over the entire surface area of the press roll. The segmented pressing face 21 can be configured as an isolated surface element; an annular, narrow surface element that wraps around the press roll 3; a surface element that follows a generating line, covers a limited circumferential section and extends over the width of the press roll 3; or in the form of a plurality of such surface elements.

To this end, for instance, the segmented pressing face 21 can be carried by a cut-out or partial printing blanket, a plastic relief printing form on which images can be set or a pressure segment 22. The pressure segment 22 is preferably releasably secured to a smooth support. Optionally, the pressure segment 22 can be adhesively bonded or attached magnetically. A pressure segment 22 having a magnetically adhesive face on its underside can be placed, for example, directly on the surface of the press roll 3. Alternatively, the segmented pressing face can be attached or positioned by using a magnetic film that is clamped onto the surface of the press roll 3 and onto which a pressure segment 22 having an underside configured to adhere magnetically can be placed. As will be understood, the surface and the inner construction of the pressure segment 22 should correspond to the described specifications regarding elasticity and smoothness. In this instance, a compressible support 23 can be provided that carries a preferably smooth, relatively firm functional layer 24.

The limited segmented pressing face 21 functions in a similar manner as when passing through the cylinder channel 19 in that the transfer film 5 is clamped in only when the segmented pressing face 21 passes through the transfer nip 6 in such a manner that the segmented pressing face makes contact with the transfer film 5. In other words, the pressing face 21 acts on the transfer film 5 only at locations where image-forming layers are actually to be transferred from the transfer film 5 onto the printing sheets.

As a result, at least two effects can be achieved in the coating module. First, the advance of the transfer film 5 can be stopped in a very advantageous manner when the region to be coated lies somewhere within the image region of the printing sheet and has not yet reached the region of the segmented pressing face 21 or the region of the segmented pressing face 21 ends before the end of the sheet region which is to be coated. Therefore, the transfer film 5 only has to be transported when the segmented pressing face 21 is in engagement in the transfer nip 6 between the press roll 3 and the impression cylinder 4. The transfer film 5 can be utilized almost completely in this way between the printing sheets which are to be coated. If an annular pressing face 21 is used, the film transport is stopped only when a channel is being passed through. If pressing faces 21 are used in the form of individual segments or a plurality of segments which are as wide as the cylinder and reach over a part of the circumference, the film advance can be stopped additionally during areas on the circumference of the press roll 3 that are free of a pressing face.

The second effect that can be achieved in the coating module is a further improvement in the utilization of the transfer film when the transfer film 5 is divided into one or more partial film webs of smaller width. The division of the transfer film is of great advantage particularly in conjunction with the segmented pressing face 21. In the case of a segmented pressing face 21, the transfer film 5 can be used in a manner which is limited to the width of the pressing face 21. The savings made in usage of the film are significant. Guiding of the film in the transfer nip 6 is improved considerably by full-surface contact of a narrow web of the transfer film 5 with the segmented pressing face 21. As noted above, the utilization of the transfer film 5 can also be improved in situations where one sheet has coating regions of different zonal length by providing an appropriate control using the device or devices for synchronizing the advance of each of the partial film webs. For this purpose, each partial film web can be further conveyed only in that precise region where the image-forming surface layer is to be applied. In the regions that are not to be coated, each partial film web can be stopped independently of the other partial film webs. Thus, unnecessary film usage does not occur. The use of partial film webs also allows different film types to be used next to one another. This enables surfaces having a different film, or different smoothness or structure to be produced.

A variety of different known working materials can be used for the partial press cover. For example, a so-called stripped rubber blanket (i.e., a printing blanket in which the rubber pressing surface has been removed to correspond with the surface which is to be active during embossing) can be used. A so-called polymeric cutting plate (e.g., from the manufacture of printing plates for flexographic applications and that can be manufactured by means of a flat-bed plotter) can be used. The polymeric cutting plate can be equipped with a support material made from aluminum or polyester if desired. A photopolymeric plate, which is used, for example, for flexographic printing, also can be used as the working material. The surface contouring of the photopolymeric plate can be manufactured by means of an exposure and washing operation also can be used. The photopolymeric plate can be provided with an aluminum plate or an aluminum film as support material as desired. A rubber blanket having a metal support can also be used as the working material. The rubber blanket can be prepared and used in the same way as a stripped rubber or printing blanket.

A support layer that optionally can provide a damping action can be provided as a base for the corresponding partial press cover. For example, a printing underblanket can be used. A base is only suitable for use with press covers that do not have any metal layers.

A variety of clamping systems can also be used, For example, a clamping spindle such as used with a rubber-covered cylinder can be used. Alternatively, so-called combination clamping rails for printing blankets or printing plates can be used. Such combination clamping rails are known from rubber-covered or form cylinders. Depending on the construction, the surface of the press-cylinder cover is also suitable for profiled embossing.

This configuration of the present invention allows cold film embossing to be useable across a broader spectrum of applications. Moreover, the changeover time is substantially reduced through the use of pre-prepared press-cylinder covers. Moreover, register automation can be introduced.

The press roll 3 of the present invention also can be configured with a register system, for example via register pins or register stops. The press cover 10 or the support of the press cover 10 can be provided with register stamped portions in a corresponding manner. In this way, the press cover 10 can be clamped by itself or on a support at any time with accurate-register and the position of the pressing segments can always be determined exactly.

The press cover 10 or the support which carries a press cover 10 having pressing segments can be clamped on the press roll 3 by means of an automatic feeding and clamping apparatus. This allows the press cover 10 to be prepared outside the coating unit 2 and to be clamped automatically during other changeover operations.

Moreover, the press roll 3 can be adjustable. This can be achieved, for example, via a register system for automatic printing-plate clamping. For this purpose, a lateral register and a circumferential register of the press roll 3 can be set in a comparable manner to a plate cylinder or form cylinder. The impression cylinder can likewise be provided with a register system for positioning the printing sheets with respect to the press roll 3 that carries the pressing segment or segments. Moreover, the circumferential, lateral and diagonal register of the printing sheets can be set using sheet transport drums that are arranged between the printing units.

Based on the foregoing, the apparatus and method of the present invention allows the transfer film coating and application modules to be handled very simply and rapidly.

### LIST OF REFERENCE NUMERALS

1 Applicator unit
2 Coating module
3 Press roll
4 Impression cylinder
5 Transfer film/film web
6 Transfer nip
7 Roll drive
8 Film supply roll
9 Film collecting roll
10 Press cover
11 Inking/dampening unit
12 Plate cylinder
13 Blanket/rubber-covered cylinder
14 Film guiding device
15 Printing-unit protection means
16 Dryer
17 Inspection device/monitoring system
18 Dancer roll
19 Cylinder channel
20 Pressing face
21 Segmented pressing face
22 Pressure segment
23 Support layer
24 Functional layer

1. An apparatus for transferring an image-forming layer from a transfer film onto a printing sheet comprising:
an applicator unit for coating the printing sheets with an adhesive for image purposes;
a coating module for transferring the image-forming layer from the transfer film onto the printing sheet, the coating module including an impression cylinder and a press roll that define a transfer nip therebetween, the transfer film being guidable through the transfer nip together with the printing sheet with a coated side of the support film in contact with the printing sheet such that the image-forming layer is transferred onto the printing sheet;
a transfer film feeding device for feeding the transfer film to the coating module and for leading it away from the coating unit, the transfer film feeding device including a drive for moving the transfer film in an operating direction; and
a film guiding device for controlling the advance of the transfer film such that the transport of the transfer film is stopped when an image-forming layer is not transferred onto the printing sheet in the transfer nip of the coating unit.

2. The apparatus according to claim 1, further including a controller operable together with the film guiding device such that the film advance is stopped during passage of a cylinder channel on the press roll that accommodates grippers of the impression cylinder with the press roll passing in a sliding manner with further contact of the transfer film.

3. The apparatus according to claim 1, wherein the press roll includes an elevated pressing face having a contoured outline and a size limited to a maximum region to be coated.

4. The apparatus according to claim 1, wherein a partial printing blanket that defines a pressing face is arranged on the surface of the press roll, the partial printing blanket being contoured in accordance with a region of the printing sheet to be coated and having an accurate fit with respect to the region of the printing sheet to be coated.

5. The apparatus according to claim 1, wherein a pressing segment is releasably carried on the surface of the press roll and defines a pressing face, the pressing segment being contoured in accordance with a region of the printing sheet to be coated.

6. The apparatus according to claim 1, wherein the press roll includes a press cover having fastening elements for securing the press cover to the press roll with an accurate fit.

7. The apparatus according to claim 1, wherein the press roll includes a press cover having one or more register punched portions.

8. The apparatus according to claim 1, wherein press roll includes a press cover and the press roll includes a positioning device for positioning the press cover relative to the impression cylinder.

9. The apparatus according to claim 7, wherein the press roll includes a register device for positioning the press cover on the press roll in conjunction with the register punched portions.

10. The apparatus according to claim 9, wherein the register device is provided in conjunction with clamping devices for the press cover.

11. The apparatus according to claim 9, wherein the press roll includes an automatic clamping device for clamping the press cover with an accurate fit.

12. The apparatus according to claim 11, wherein the automatic clamping device for clamping the press cover is operable on the press roll in conjunction with the register device.

13. An apparatus for transferring an image-forming layer from a transfer film onto a printing sheet comprising:
a transfer film divided into a plurality of narrow partial film webs;
an applicator unit for coating the printing sheets with an adhesive for image purposes;
a coating module for transferring the image-forming layer from the transfer film onto the printing sheet, the coating module including an impression cylinder and a press roll that define a transfer nip therebetween, the transfer film being guidable through the transfer nip together with the printing sheet with a coated side of the support film in contact with the printing sheet such that the image-forming layer is transferred onto the printing sheet, the plurality of narrow partial film webs being feedable to the transfer nip in adjacent relation to each other; and
a transfer film feeding device for feeding the transfer film to the coating module and for leading it away from the coating unit, the transfer film feeding device including a drive for moving the transfer film in an operating direction.

14. The apparatus according to claim 13, wherein each of the partial film webs are provided with a different image-forming layer.

15. The apparatus according to claim 13, wherein the press roll includes an elevated pressing face having a contoured outline and a size limited to a maximum region of the printing sheet to be coated.

16. The apparatus according to claim 13, a partial printing blanket that defines a pressing face is arranged on the surface of the press roll, the partial printing blanket being contoured in accordance with a region of the printing sheet to be coated and having an accurate fit with respect to the region of the printing sheet to be coated.

17. The apparatus according to claim 16, wherein a pressing segment is releasably carried on the surface of the press roll and defines a pressing face, the pressing segment being contoured in accordance with a region of the printing sheet to be coated.

18. The apparatus according to claim 13, wherein the press roll includes a press cover having fastening elements for securing the press cover to the press roll with an accurate fit.

19. The apparatus according to claim 13, wherein the press roll includes a press cover having one or more register punched portions.

20. The apparatus according to claim 13, wherein press roll includes a press cover and the press roll includes a positioning device for positioning the press cover relative to the impression cylinder.

21. The apparatus according to claim 19, wherein the press roll includes a register device for positioning the press cover on the press roll in conjunction with the register punched portions.

22. The apparatus according to claim 21, wherein the register device is provided in conjunction with clamping devices for the press cover.

23. The apparatus according to claim 21, wherein the press roll includes an automatic clamping device for clamping the press cover with an accurate fit.

24. The apparatus according to claim 23, wherein the automatic clamping device for clamping the press cover is operable on the press roll in conjunction with the register device.

25. A method for coating a printing sheet in a sheet-fed rotary printing press comprising the steps of:
coating an image area of the printing sheet with an adhesive in an application unit; and
guiding a transfer film comprising a support film and an image-forming layer through a transfer nip in a coating module under pressure together with the printing sheet, the transfer film comprising a support film and an image-forming layer containing image elements and the transfer nip being defined by an impression cylinder and a press roll;
wherein the transfer film is guided through the transfer nip with the image-forming layer pressed against the printing sheet such that the image-forming layer is separated from the support film and adheres to the printing sheet and wherein the transfer film is only pressed against the printing sheet in the image area.

26. The method according to claim 25, wherein a pressure segment is attached to the press roll, the pressure segment including a pressing face having a size corresponding to the size of the image area and wherein the transfer film is only fed to the transfer nip in an area corresponding to an axial section of the press roll provided with the pressing face.

27. The method according to claim 26, wherein the transfer film comprises a plurality of partial film webs that are fed to the transfer nip in the axial section of the press roll provided with the pressing face.

28. The method according to claim 25, wherein a pressure segment is arranged on the press roll, the pressure segment including a pressing face having a size corresponding to the image area and wherein the transfer film is only fed to the transfer nip in an area corresponding to a circumferential section of the press roll provided with the pressing face.

29. The method according to claim 28, wherein the transfer film is incrementally fed to the transfer nip in an axial section of the press roll provided with the pressing face.

30. The method according to claim 25, wherein the image-forming layer is colored.
